(19) United States
(12) Patent Application Publication
(10) Pub. No.: US 2024/0368007 A1
(43) Pub. Date: Nov. 7, 2024

(54) AN ENERGY EFFICIENT AND HIGH PERFORMANCE NON-CONTACT PHYSIO-ELECTRICAL REACTOR FOR WASTEWATER TREATMENT

(71) Applicant: INPHLOX WATER SYSTEMS PRIVATE LIMITED, Mumbai, Maharashtra (IN)

(72) Inventors: Sarthak MEHTA, Mumbai Maharashtra (IN); Amrit Om NAYAK, Mumbai Maharashtra (IN); Krunal Nitin PATEL, Mumbai Maharashtra (IN)

(21) Appl. No.: 18/686,048

(22) PCT Filed: Aug. 10, 2022
(86) PCT No.: PCT/IN2022/050718

§ 371 Date: Feb. 23, 2024

(30) Foreign Application Priority Data
Aug. 26, 2021 (IN) 202121038739

(51) Int. Cl. C02F 1/461

(52) U.S. Cl. CPC C02F 1/46109; C02F 2001/46128; C02F 2001/46133; C02F 2001/46157; C02F 2201/4613; C02F 2201/46175

(57) ABSTRACT

An energy efficient, high-performance reactor (1) for wastewater treatment is disclosed herein. The reactor (1) has a chamber (14) provided with an inlet (11) to allow the entry of the wastewater, and an outlet (21) to allow the treated water to exit. The chamber includes an electrode assembly (13), wherein each of the pair of electrodes includes a layer of metal matrix composites. A polarity switching DC power is provided across the electrode assembly (13), thereby inducing an array of microelectrodes for enhanced surface area and better efficiency for the reaction.

### FIELD OF INVENTION

The present invention relates to an energy efficient, high-performance apparatus for the purpose of wastewater treatment. More particularly, the present invention discloses a smart non-contact physio-electrical reactor for efficient wastewater treatment, which provides larger & uniform surface area for reaction, yet has a longer life.

### BACKGROUND & PRIOR ART

Wastewaters such as raw sewage, industrial effluents, brackish water, gray water, etc., may contain particulates, dissolved organic and inorganic matter and microbes, such as suspended solid particles, human waste, food, scraps, oils, soaps, chemicals, heavy metals, pathogens, bacteria, entrained gas and other hazardous inorganic and organic substances. With an increase in the consumption of water and its corresponding shortage, as well as the need for a cleaner environment, it has now become pertinent to treat the water so as to render it suitable for re-use. Several studies have indicated that by 2030, water will become scarcer than oil, with the water demand outstripping its supply by over 40%. Erratic rainfall, depleting fresh water and ground water reserves and extensive pollution has led to the unavailability of usable water resulting in acute water shortage in many regions around the world.

The current methods and techniques regarding wastewater treatment involve (i) degradation or neutralization of chemical and biological matter; (ii) reduction of sludge/by-product, gaseous odour from methane, ammonia and hydrogen sulphide; and (iii) Removal of nutrients, heavy metals and forever chemicals like Per- and polyfluoroalkyl substances. The manufacturers further prefer a technology that reduces capital investment and operational cost. Attempted combination of cost related factors and aforementioned technological factors often leads to compromising any one factor. Further, the traditional wastewater treatment approach has major operational drawbacks which affect its performance and results in inconsistent treatment efficiency.

Some of the disadvantages with the existing wastewater treatment technologies are briefly elaborated herein:

High energy consumption: The conventional technologies are commonly batch processes which exhibit inherent inefficiencies such as pumping work losses, poor primary treatment, and inefficient aeration or mixing resulting in inconsistent treatment efficiency and higher process time.
Manpower: The known wastewater treatment systems are manually operated and require continuous monitoring and control. Monitoring and control of such systems can be demanding during inflow variations and seasonal changes. Further, operator management can account for up to 30% of the total operational costs and loses due to human error and resultant downtime of water assets.
Sludge production: Sludge is the residue generated during physical, chemical and biological treatment of waste water. A major environmental challenge for wastewater treatment is the disposal of excess sludge produced during the treatment process which might sometimes be toxic thereby making it difficult for disposal.
Footprint: Other major problem faced by conventional wastewater treatment systems is a considerably large footprint demand. They are costly to construct, and the settling tanks and aeration basins occupy substantial areas. Due to this the treatment facilities may have to be situated away from the cities, thereby increasing operation costs due to Transportation and inefficiencies in electro-mechanical equipment and leakages. Also, with the space constraint in all major cities, space availability is a major concern.
Failing downstream equipment: Varying influent load and nature of pollutants in the influent adversely affect the treatment process resulting in inconsistent treatment and constant equipment failure.
Failure to meet norms: Incomplete treatment, varying effluent water quality, organic overloading, physical short-circuiting, high chemical dosing, overdependence on chemicals in primary treatment results in poor water quality and inability to meet norms.

The applicant of the present invention has addressed the aforesaid drawbacks in its granted Patent No. IN306429, in which wastewater treatment is carried out by electrocoagulation. The method involves treating an influent wastewater stream by an ozone-assisted electrocoagulation process in at least one electrocoagulation reactor to produce a floc-containing wastewater stream. The method further includes reducing the process time by 30-35% by selectively controlling said ozone-assisted electrocoagulation process through real-time monitoring of the influent wastewater characteristics and consequent adjustment of at least one process parameter selected from influent flow rate, ozone flow rate, electrical loading of electrodes, process time and reaction contact time; filtering said floc-containing wastewater stream through a filtration unit comprising at least one filter selected from a cross-flow filter and a media filter, to obtain a filtered wastewater stream and sludge; and disinfecting and de-fouling said filtered wastewater stream by an ozone-assisted UV process in a UV treatment chamber to obtain treated water.

Electrocoagulation, which is a preferred method in the above document, is based on breaking of the particles in aqueous medium by passing the current through the aqueous medium. It is one of the most popular method for treating industrial wastewater containing polluted particles, ranging from chemical waste, minerals to bacteria, algae, larvae.

At present, researchers have identified a methodology to incorporate three-dimensional metal matrix composite that can be used for wastewater treatment. One such possible application is mentioned in WO2004043875. The said document relates to metal-nonmetal composites, and a method of preparation thereof. Further, the said method in WO'875 uses pressure less infiltration of ceramic based metal matrix composites as a tool for wastewater treatment.

The present invention proposes a novel approach which achieves appropriate technological factors as well as capital investment and cost.

### SUMMARY OF INVENTION

The present invention discloses an efficient, high-performance reactor for wastewater treatment.

In an embodiment, the reactor comprises a chamber provided with an inlet at a lower end of a side to admit an entry of the wastewater; and an outlet at a higher end of a side opposite to that of the inlet to allow treated water to exit.

In an embodiment, the chamber of the reactor comprises at least one housing sections. Each housing section includes at least one pair of electrode assembly having perforated sheets covering at least a negative electrode from all sides. Further, each pair of electrode assembly encloses a space adapted to incorporate a metal matrix composite layer.

In embodiment, a power source is connected across the electrode assembly. Preferably, the power source is a DC source. At least one connector is provided therein for connecting the electrode assembly to the power source. Preferably, the connector is a single common connector, such as metallic bus bar, or more preferably, a c-bar.

An important aspect of the invention is that the DC source is adapted to switch its polarity at a predetermined frequency. A DC power with switching polarity induces bipolar charge distribution on the metal matrix surface, thereby inducing microelectrodes on the surface of the metal matrix composites.

In an embodiment, the metal matrix composite is preferably selected from Activated Carbon, Manganese Dioxide, Graphene, Titanium dioxide, Iron, Aluminum, Turnings of Iron, Aluminum and their alloys. However, the metal matrix composite is not limited to the aforesaid materials.

Further, the metal matrix has very high packing density, thereby enhancing surface area available for reactions. The packing density is present between 30% to 80% of the chamber volume between a pair of electrode assembly. The amount of packing density is determined by factors depending upon different wastewater treatments.

In another embodiment, more than one pair of electrodes and applicable perforated sheets as described above sandwiching the metal matrix composites, are provided therein to enhance treatment efficiency for different kinds of wastewater.

In another embodiment, a feedback module is provided to the reactor which collects the data related to amount of remaining impurities. The feedback module comprises of plurality of sensors to detect the quality of the fluid, and at least one controller.

The present invention further discloses an efficient, high performance, non-contact, physio-electric method for wastewater treatment by employing the reactor.

The method preferably comprises steps of: allowing entry of the wastewater through an inlet provided at a chamber of the reactor, wherein the wastewater is passed through at least one pair of electrode assembly having perforated sheets covering at least a negative electrode from all sides; passing a polarity switching current through at least one pair of electrode assembly which contains a metal matrix composite layer, thereby creating an array of microelectrode on the metal matrix composite layer, thereby enhancing a surface area for electrolysis of the effluent particles, and uniformity for the reactions; and allowing exit of the treated water from an outlet provided at the chamber of the reactor.

### BRIEF DESCRIPTION OF DRAWINGS

Following figures illustrate various embodiments, including the best embodiment, of the invention

FIG. 1 illustrates a cross sectional view of the reactor (1) of the invention.

FIG. 2 illustrates a top view of the reactor (1).

FIG. 3 illustrates an isometric view of the reactor (1).

FIG. 4 illustrates internal components of the reactor (1)

FIG. 5 illustrates reactions take place in the pair of electrodes in the electrode assembly (13).

FIG. 6(a) illustrates the arrangement within the electrode assembly (13).

FIG. 6(b) illustrates a side view of the electrode assembly (13).

### DETAILED DESCRIPTION OF INVENTION

Accordingly, the present invention discloses an apparatus, or more precisely, an energy efficient, high performance non-contact, physio-electric reactor for wastewater treatment.

Certain terms and expression used in the specification are intended to describe certain components of the embodiments. Said terms and expressions may have usual meaning. For example, “wastewater” is liquid which has contaminants such as human waste, food, soaps, oils, chemicals etc which are harmful to human as well as environmental health. “Metal matrix composites” is a composite material consisting of metals, their alloys, selected non-metals etc., and which are through different reinforcing phases. One of the components of matrix is essentially metal. “DC power supply” is a linear, non-varying supply (Direct Current—DC).

The invention may be comprehended by referring to figures appended at the end of the specification. However, it may be noted that the figures represent a preferred embodiment and its variation, are not intended to restrict the scope of the invention.

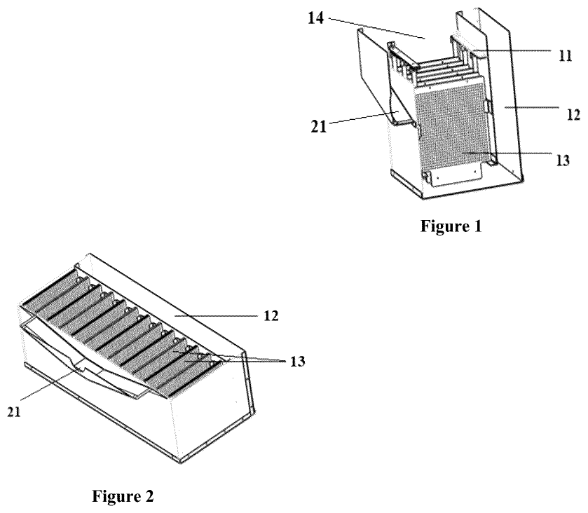

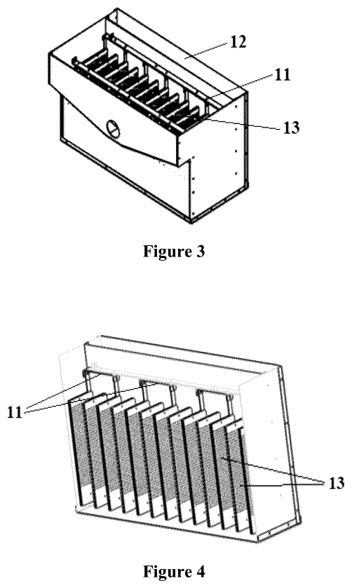

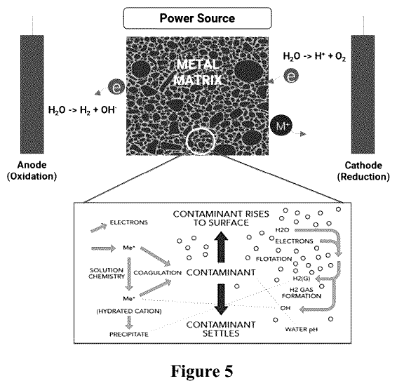

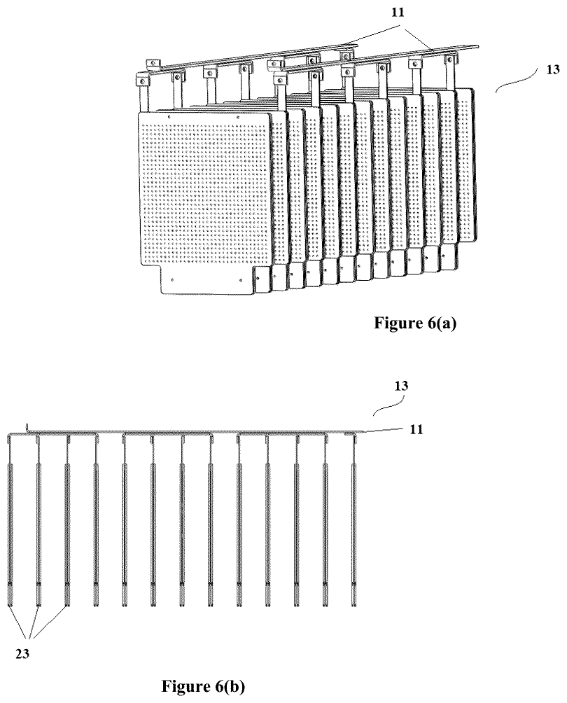

Referring to FIGS. 1 to 6, the invention describes an efficient, high performance, non-contact, physio-electric reactor for wastewater treatment. The reactor comprises a chamber (14) provided with an inlet (12) at a lower end of a side to admit an entry of the wastewater; and an outlet (21) at a higher end of a side opposite to that of the inlet (12) to allow treated water to exit; the chamber (14) comprises at least one housing sections, wherein the each housing section includes at least one pair of electrode assembly (13), and each pair of electrode assembly (13) encloses a space (23) incorporating a metal matrix composite layer; a power source for providing voltage across the electrode assembly (13), wherein the power source is configured to switch polarity at a pre-determined variable frequency; and at least one connector (11) connecting the electrode assembly (13) to the power source. The power source is a polarity switching DC source at a predetermined variable frequency that induces an array of microelectrodes on metal matrix composites, thereby enhancing a surface area for electrolysis of the effluent particles, and uniformity for the reactions.

Referring to FIG. 1, FIG. 1 illustrates a cross-sectional view of the reactor (1) of the present invention. The reactor (1) is provided with an electrode assembly (13), which comprises of a series of electrodes with metal matrix composite layer in between each neighboring electrode. The electrodes are powered by a common external power source, which is distributed to each electrode through a connector (11), preferably a metallic busbar. Preferably, the metallic bar (11) is a c-bus bar. However, the purpose of the present invention can be served by using threaded rods, wired connection and such. An inlet (12) is provided to allow the entry of the influent stream. The reactor is hydraulically designed so as to ensure that no water is expelled from the reactor without treatment and that proper flow is achieved. The reactor also has an optional gravel bed under the electrode assembly for high temperature applications. The gravel bed improves isolation, increases aeration and reduces bed clogging.

FIG. 2 illustrates a top view of the proposed reactor. As per FIG. 2, an outlet (21) is provided for the treated water to exit from the reactor (1). A space (23) between the electrodes is provided to charge metal matrix composites, for the purpose of the treatment of water when it passes through electrode assembly (13). Once the influent stream passes from between the parallel electrode setup and the metal matrix bed, it overflows into a cone bottom chamber that drains the treated water out.

In a preferred embodiment, the metal matrix composite is preferably selected from Activated Carbon, Manganese Dioxide, Graphene, Titanium dioxide, Iron, Aluminum, Turnings of Iron, Aluminum and their alloys. However, the metal matrix composite is not limited to the aforesaid materials. The choice of the composites allows to achieve targeted treatment and therefore making the whole process energy efficient and higher performance.

In one of the important aspects of the invention, a DC power passing through the electrode assembly (13) is adapted to switch polarity at a pre-determined variable frequency. It may be noted that the frequency of switching depends upon the type of wastewater and the pollutant load in it. For example, frequency of switching for low pollutant load is between 100 to 120 seconds, whereas the said value may lie between 30 to 90 seconds. However, the frequency of switching is not limited to the above values. Such switchable DC power induces dipole moment in the metal matrix composite layer, thereby inducing an array of microelectrodes of the metal matrix composite layer. The said micro-electrodes are tiny, microscopic electrodes which are preferably having a regular size and shape. The size of each microelectrode is preferably not exceeding 15 mm. In specific cases depending upon the type of the wastewater, metal casting is used to attain regular shapes, such as sphere, to obtain optimized results. The array microelectrodes provide dramatically increased surface area for electrolysis of the pollutant particles. It improves the surface life by 40% and homogeneous performance by 25%.

Another advantage of the polarity switching DC power is better averaged or consistent electromagnetic flux over time and finer control over microelectrodes. Polarity switching DC power also provides better reaction homogeneity across the surface.

Further, the metal matrix composite employed in the present invention performs electro-adsorption with a 15% higher efficiency and 30% better self-life aided by in-situ regeneration by polarity reversal. The coagulation and oxidation ability of such a matrix supersedes any conventional coagulation chemical with 60% higher pollutant removal in the form of COD, 70% reduction in treatment time and 60% greater degradation and mineralization of organic pollutant solvents on an average aided by greater production of hydroxyl radical which is the strongest oxidizing agent in nature and other super oxidants. Furthermore, the metal matrix composites utilized in the present invention have a certain cell size (˜0.01% to 0.5% of power electrode surface area) and void packing density (˜0.3 to 0.8 subject to type of wastewater and pollutant load), thereby availing high surface area for treatment reactions. The active surface area to volume ratio i.e. S/V ratio can range anywhere between 350 to 600 (1/m) based on the material chosen and the design of the bed. The packing density of the metal matrix composites is very high, thereby reducing operational and maintenance cost. In contrast to a conventional electrocoagulation unit, which involves cumbersome plate fixtures and variable efficiency as the electrode gets consumed, the metal matrix composites of the present invention maintain a uniform charge density thereby achieving consistent performance and treatment of water. This reduces the overall skilled human resource required to sustain optimal output in daily operations. Also, with higher reaction efficiency the overall current required to drive the system drops by 25% thereby reducing the power consumed and resultant electrical cost associated. This reduces the overall cost of operating the system and treating water by 20%.

In a preferred embodiment, the negative electrodes of each pair of electrodes (13) is wrapped by the perforated sheets, thereby increasing throughput. The presence of perforated sheets renders more homogenous mixture of micro-anodes and micro-cathodes and aids both oxidation and coagulation, which is more suitable for suspended and dissolved pollutants.

In yet another embodiment, the inlet of wastewater is split across symmetrical sub-chambers that are present within the chamber. Each sub-chamber may be operated as an isolated reactor setup, which enables easy troubleshooting. The provision also assists to segregate hazardous and highly polluted streams to treat them separately before mixing them with the bulk. The interelectrode distances and resultant flux density are optimised to ensure maximum treatment with minimal operation and maintenance required.

However, in another embodiment, no perforated sheets are used surrounding negative electrode. Whether to use the perforated sheets is subject to type of wastewater, which determines the desired reaction. The inventors have found that absence of perforated sheets results in the formation of micro-anodes in a greater quantity, which leads to dominant physio-electrical coagulation and works better for higher suspended solids in wastewater. On the other hand, as stated earlier, the presence of perforated sheets renders more homogenous mixture of micro-anodes and micro-cathodes and aids both oxidation and coagulation, which is more suitable for suspended and dissolved pollutants.

The present invention encompasses both physio-electrical coagulation and physio-electrical oxidation as an oscillating function of current supplied. Each of the processes can be enhanced by dynamic controls placed to provide feedback corrective mechanisms. The reactor settings are adjusted based on the influent water stream to ensure effective and efficient treatment. In an embodiment, such settings are incorporated into the present reactor without deviating from the already standardised design and processes.

The present invention involves micro-electrolysis which enhances the total active surface area by creating unit microscopic anodes and cathodes on the electrode assembly (13) in a bipolar configuration thereby increasing active reaction area and improving reaction rate. This induced dipole system can then release ions into the influent stream aiding coagulation as well as provide exposed surface area for redox reactions.

The electron released by the electrolysis into the water stream is recirculated through additional loads reducing the plurality of power sources currently employed in IN306429. The power is tapped from primary reactors to operate relatively low power redox reactors optimized for pollutant oxidation thereby driving up process efficiency.

In yet another embodiment, the reactor includes a feedback module, which comprises of a plurality of sensors to detect the amount of pollutants still remaining in the fluid; and a controller.

The invention further discloses an efficient, high performance, non-contact, physio-electric method for wastewater treatment by employing a reactor (1) comprising steps of: (i) allowing entry of the wastewater through an inlet (12) provide at a chamber (14) of the reactor (1), wherein the wastewater is passed through at least one pair of electrode assembly (13); (ii) passing a polarity switching current through the at least one pair of electrode assembly (13) which contains a metal matrix composite layer, thereby creating an array of microelectrode on the metal matrix composite layer, thereby enhancing a surface area for electrolysis of the effluent particles, and uniformity for the reactions; and (iii) allowing exit of the treated water from an outlet (21) provided at the chamber (14) of the reactor. In another embodiment, one more perforated sheets are provided, covering at least a negative electrode of the electrode assembly (13).

The advantages of the invention are demonstrated by the following examples:

| | | Conventional | Other |
|---|---|---|---|
| | | Electrocoagulation and | Conventional |
| | Present Invention | Micro-electrolysis | Water Treatment |
| Parameters | (A) | systems (B) | Solutions (C) |
| Polarity Control | 25-30% better (wrt to B) | Standard (Pulsed or | Not Applicable |
| | | switching based coarse | |
| | | control) | |
| Active Surface Area | 60-70% higher (Accurate | Standard (primarily single | Not Applicable |
| | control over formation of | pole surfaces) | |
| | single pole and bipolar | | |
| | surfaces) (wrt to B) | | |
| Power Transmission to | Direct and Indirect | Only direct | Not Applicable |
| Reactor Bed | (Induced bed | | |
| | energization) are both | | |
| | possible (wrt to B) | | |
| Power Electrode Life | 30% Longer (wrt to B) | Short | Not Applicable |
| Primary Matrix Bed Life | 40% Longer (wrt to B) | Short | Not Applicable |
| Passivation of Primary | 30-40% Lower (wrt to C) | Inconsistent (up to 10% | Medium to High |
| Reaction or pollution | | lower) (wrt to C) | |
| breakdown sites (Note: | | | |
| Lower Passivation is better) | | | |
| Treatment Homogeneity per | High (40-50% higher) | Inconsistent (up to 25% | Low |
| unit volume in primary | (wrt to C) | higher) (wrt to C) | |
| reactor or vessel | | | |
| Ionic Homogeneity and | High (40-50% higher) | Low | Not Applicable |
| Electron Density | (wrt to B) | | |
| Matrix Bed Choking | 40% lower (wrt to B) | Frequent | Not Applicable |
| Treatment Time | 55% lower (wrt to C) | 30% lower (wrt to C) | High |
| Primary Process Retention | 40% lower (wrt to C) | 20% lower (wrt to C) | High |
| Time | | | |
| Footprint (Spatial and | 70% lower (wrt to C) | 40% lower (wrt to C) | High |
| Volumetric) | | | |
| Throughput | 60% higher (wrt to C) | 35% higher (wrt to C) | Low |
| Energy Footprint | 30% lower (wrt to C) | 20% lower (wrt to C) | High |
| Cost | 40% lower (wrt to C) | 25% lower (wrt to C) | High |
| Average Sludge Generation | 65% lower (wrt to C) | 55% lower (wrt to C) | High |
| Manpower Dependence | 50% lower (wrt to C) | 40% lower (wrt to C) | High |
| Variable Load Handling | 40% higher (wrt to C) | 15% higher (wrt to C) | Low |
| (water quality fluctuation) | | | |
| Water Recovery Potential | 60% higher (wrt to C) | 40% higher (wrt to C) | Inconsistent and |
| | | | low |
| Modularity | Very High | Limited | No Modularity |
| Technology Integration | Very High | Limited | Limited |
| Potential | | | |
| Data Driven Smart Reactor | High data feedback and | 15% better performance | Negligible or Nil |
| Technology | dynamic response | (wrt to C) | |
| | (40% better performance) | | |
| | (wrt to C) | | |

The description provided herein is by way of examples and illustrations. Various features in the description are provided with reference to various non-limiting embodiments in accordance with the present invention. The embodiments described in the specification are intended to merely explain the use and functioning of the invention. Any person skilled in the art may be able to envisage the present invention by referring to the present specifications and set of drawings

We claim:

1. An efficient, high performance, non-contact, physio-electric reactor for wastewater treatment comprising
a chamber (14) provided with an inlet (12) at a lower end of a side to admit an entry of the wastewater; and an outlet (21) at a higher end of a side opposite to that of the inlet (12) to allow treated water to exit;
the chamber (14) comprises
at least one housing sections, wherein each housing section includes at least one pair of electrode assembly (13), and each pair of electrode assembly (13) encloses a space (23) incorporating a metal matrix composite layer;
a power source for providing voltage across the electrode assembly (13), wherein the power source is DC source configured to switch polarity at a variable pre-determined frequency; and
at least one connector (11) connecting the electrode assembly (13) to the power source;
wherein polarity switching source at a predetermined variable frequency inducing an array of alternating microelectrodes on metal matrix composites, thereby enhancing a surface area for electrolysis of the effluent particles, and uniformity for the reactions.

2. The reactor as claimed in claim 1, wherein the composites in metal matrix layer are selected from materials, which includes, but not limited to, Activated Carbon, Manganese Dioxide, Graphene, Titanium dioxide, Iron, Aluminum, Turnings of Iron, Aluminum and alloys therein.

3. The reactor as claimed in claim 1, wherein the pre-determined frequency of polarity switching is ranging from 20 Hz to 1000 Hz.

4. The reactor as claimed in claim 1, wherein the connector (11) is a metallic bar.

5. The reactor as claimed in claim 1, wherein the connector (11) is a c-bar connector.

6. The reactor as claimed in claim 1, wherein a packing density of the metal matrix composites is between 30% to 80%.

7. The reactor as claimed in claim 1, wherein a feedback module ( . . . ) is provided to measure the quality of the wastewater comprising a plurality of sensors, and a controller.

8. The reactor as claimed in claim 1, wherein the at least one negative electrode is covered by one or more perforated sheets.

9. An efficient, high performance, non-contact, physio-electric method for wastewater treatment by employing a reactor (1) comprising steps of:
(i) allowing entry of the wastewater through an inlet (12) provide at a chamber (14) of the reactor (1), wherein the wastewater is passed through at least one pair of electrode assembly (13) having perforated sheets covering at least a negative electrode from all sides;
(ii) passing a DC polarity switching current through the at least one pair of electrode assembly (13) which contains a metal matrix composite layer, thereby inducing an array of microelectrode on the metal matrix composite layer, thereby enhancing a surface area for electrolysis of the effluent particles, and uniformity for the reactions; and
(iii) allowing exit of the treated water from an outlet (21) provided at the chamber (14) of the reactor.
